(19) United States
(12) Patent Application Publication
(10) Pub. No.: US 2010/0060662 A1
(43) Pub. Date: Mar. 11, 2010

(54) VISUAL IDENTIFIERS FOR VIRTUAL WORLD AVATARS

(75) Inventor: Kenneth Law, Castro Valley, CA (US)

Correspondence Address: MARTINE PENILLA & GENCARELLA, LLP, 710 LAKEWAY DRIVE, SUITE 200, SUNNYVALE, CA, 94085, US

(73) Assignee: Sony Computer Entertainment America Inc.

(21) Appl. No.: 12/207,420

(22) Filed: Sep. 9, 2008

(51) Int. Cl. G09G 5/00

(52) U.S. Cl. 345/629

(57) ABSTRACT

In one embodiment, a method for applying body modifications to an avatar in a virtual world environment is defined. The method includes an operation to detect movement of the avatar into a facility that is a virtual world representation of a body modification facility. In another operation the method requests submission of a body modification to be applied to the avatar. The method also includes an operation to receive the submission of the body modification where the submission is a graphic illustration of the body modification. The method sends the submission of the body modification to a review process in order to monitor body modifications within the virtual world environment. In another operation, the method applies the body modification to the avatar once the body modification has passed the review process.

### BACKGROUND

### Description of the Related Art

The video game industry has seen many changes over the years. As computing power has expanded, developers of video games have likewise created game software that takes advantage of these increases in computing power. To this end, video game developers have been coding games that incorporate sophisticated operations and mathematics to produce a very realistic game experience.

Example gaming platforms, may be the Sony Playstation2 (PS2), Sony Playstation Portable (PSP) or Sony Playstation3 (PS3) each of which is sold in the form of a game console. As is well known, the game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. The game console is further designed with an optical disc tray for receiving game compact discs for local play through the game console. Online gaming is also possible, where a user can interactively play against or with other users over the Internet.

As game complexity continues to intrigue players, game and hardware manufacturers have continued to innovate to enable additional interactivity and computer programs. Some computer programs define virtual worlds. A virtual world is a simulated environment in which users may interact with each other via one or more computer processors. Users may appear on a video screen in the form of representations referred to as avatars. The degree of interaction between the avatars and the simulated environment is implemented by one or more computer applications that govern such interactions as simulated physics, exchange of information between users, and the like. The nature of interactions among users of the virtual world is often limited by the constraints of the system implementing the virtual world.

It is within this context that embodiments of the invention arise.

### SUMMARY OF THE INVENTION

Broadly speaking, the present invention fills these needs by providing computer generated graphics that depict a virtual world. The virtual world can be traveled, visited, and interacted with using a controller or controlling input of a real-world computer user. The real-world user in essence is playing a video game, in which he controls an avatar (e.g., virtual person) in the virtual environment. In this environment, the real-world user can move the avatar, strike up conversations with other avatars, and view online content. Similar to the real-world, avatars within the virtual environment can be differentiated by clothing, hairstyles, facial characteristics and the like.

Additionally, body modifications are provided to allow real-world users to differentiate their avatars from other avatars. These body modifications allow for a more immersive and real-world experience within the virtual world. Allowing real-world users to apply body modifications can result in avatars that more accurately reflect real-world users or allow real-world users to establish more realistic and more expressive alter egos within the virtual world. These modifications can be generated by one or more computer systems that run program instructions to simulate the real-world environment. The program instructions define useful steps that can be processed, stored on a memory device, and exchanged over networks. The instructions, once processed, enable a solution to a known problem of lack of real-world to virtual world translations, and thus provide for more realistic and robust representations over previous processing attempts.

In one embodiment, a method for applying body modifications to an avatar in a virtual world environment is defined. The method includes an operation to detect movement of the avatar into a facility that is a virtual world representation of a body modification facility. In another operation the method requests submission of a body modification to be applied to the avatar. The method also includes an operation to receive the submission of the body modification where the submission is a graphic illustration of the body modification. The method sends the submission of the body modification to a review process in order to monitor body modifications within the virtual world environment. In another operation, the method applies the body modification to the avatar once the body modification has passed the review process.

In another embodiment, a computer implemented method for executing a network application is disclosed. The network application is defined to render a virtual environment that is depicted by computer graphics and includes an operation that generates an animated user within the virtual environment. The method also includes an operation that generates a facility within the virtual environment that is rendered as an interactive virtual representation of a body alteration business. The method also detects movement of the animated user into a facility and provides interaction between a facility employee and the animated user. The facility employee is an application-controlled avatar, and the interactions are rendered from a perspective of the animated user. The method includes interactions that request submission of a proposed body alteration, receives the proposed body alteration, and sends the proposed body alternation to be approved. The method also animates the application of an approved body alteration, the animation rendered from a perspective of the animated user observing the application of the body alteration in substantially real-time.

### BRIEF DESCRIPTION OF THE DRAWINGS

The invention, together with further advantages thereof, may best be understood by reference to the following description taken in conjunction with the accompanying drawings.

FIG. 1A illustrates a graphic diagram of a conceptual virtual space, in accordance with one embodiment of the present invention.

FIG. 1B illustrates a virtual space 100b, defining additional detail of a virtual world in which user A may move around and interact with other users, objects, or communicate with other users or objects, in accordance with one embodiment of the present invention.

FIG. 2A is another exemplary illustration of a virtual space in accordance with one embodiment of the present invention.

FIG. 2B is a representative illustration shown on screen 154 to the real-world user 102′ after user A 102 enters the body modification business, in accordance with one embodiment of the present invention.

FIGS. 3A and 3B illustrate a body modification selection process that occurs within the body modification business, in accordance with one embodiment of the present invention.

FIGS. 4A and 4B illustrate an exemplary sequence that is displayed on screen 154 when a user selects to upload custom artwork, in accordance with one embodiment of the present invention.

FIG. 5 is a flow chart illustrating operations to examine uploaded artwork, in accordance with one embodiment of the present invention.

FIGS. 6A-6C are exemplary schematics illustrating a technique to extract and scan an uploaded image 600 for comparison to known trademarks and images, in accordance with one embodiment of the present invention.

FIGS. 6D-6F are exemplary screens illustrating how a user can share approved artwork, in accordance with one embodiment of the present invention

FIG. 7 illustrates how permissions allow particular viewers to see virtual body art while other viewers are blocked from seeing the virtual body art, in accordance with one embodiment of the present invention.

FIG. 8 is an exemplary flow chart illustrating how virtual body modifications are filtered, in accordance with one embodiment of the present invention.

FIG. 9 schematically illustrates the overall system architecture of the Sony® Playstation 3® entertainment device, a console having controllers for implementing an avatar control system in accordance with one embodiment of the present invention.

FIG. 10 is a schematic of the Cell processor 928 in accordance with one embodiment of the present invention.

### DETAILED DESCRIPTION

Embodiments of computer-generated graphics that depict a virtual world are provided. The virtual world can be traveled, visited, and interacted with using a controller or controlling input of a real-world computer user. The real-world user in essence is playing a video game, in which he or she controls an avatar (e.g., virtual person) in the virtual environment. In this environment, the real-world user can move the avatar, have conversations with other avatars, and view and interact with content such as advertising, interactive demonstrations, or online games.

In one embodiment, program instructions and processing is performed to apply body modifications to avatars within the virtual world. The procedure to apply body modifications includes, but is not limited to selecting pre-approved artwork or submitting user-generated artwork for approval. In one embodiment, when submitted artwork is approved, a user can choose to share the artwork with others. In still another embodiment, user preferences establish permissions that determine which body modifications are visible on other users and prevent body modifications from being applied to an avatar. Similar to body modifications on real-world individuals, the body modifications include, but are not limited to permanent tattoos, temporary tattoos (such as henna tattoos), piercings, and brandings. In order to provide a virtual world environment acceptable to all ages, user-generated content can be screened or filtered in order to prevent vulgarity, profanity and the misuse to copyrighted or trademarked images and slogans. In one embodiment, automated image and text filters are used to moderate user-generated artwork and body modifications. In other embodiments, combinations of automated filters are used in conjunction with actual human review of user-generated content.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to obscure the present invention.

According to an embodiment of the present invention users may interact with a virtual world. As used herein the term virtual world means a representation of a real or fictitious environment having rules of interaction simulated by means of one or more processors that a real user may perceive via one or more display devices and/or may interact with via one or more user interfaces. As used herein, the term user interface refers to a real device by which a user may send inputs to or receive outputs from the virtual world. The virtual world may be simulated by one or more processor modules. Multiple processor modules may be linked together via a network. The user may interact with the virtual world via a user interface device that can communicate with the processor modules and other user interface devices via a network. Certain aspects of the virtual world may be presented to the user in graphical form on a graphical display such as a computer monitor, television monitor or similar display. Certain other aspects of the virtual world may be presented to the user in audible form on a speaker, which may be associated with the graphical display.

Within the virtual world, users may be represented by avatars. Each avatar within the virtual world may be uniquely associated with a different user. Optionally, the name or pseudonym of a user may be displayed next to the avatar so that users may readily identify each other. A particular user's interactions with the virtual world may be represented by one or more corresponding actions of the avatar. Different users may interact with each other in the public space via their avatars. An avatar representing a user could have an appearance similar to that of a person, an animal or an object. An avatar in the form of a person may have the same gender as the user or a different gender. The avatar may be shown on the display so that the user can see the avatar along with other objects in the virtual world.

Alternatively, the display may show the world from the point of view of the avatar without showing itself. The user's (or avatar's) perspective on the virtual world may be thought of as being the view of a virtual camera. As used herein, a virtual camera refers to a point of view within the virtual world that may be used for rendering two-dimensional images of a 3D scene within the virtual world. Users may interact with each other through their avatars by means of the chat channels associated with each lobby. Users may enter text for chat with other users via their user interface. The text may then appear over or next to the user's avatar, e.g., in the form of comic-book style dialogue bubbles, sometimes referred to as chat bubbles. Such chat may be facilitated by the use of a canned phrase chat system sometimes referred to as quick chat. With quick chat, a user may select one or more chat phrases from a menu.

In embodiments of the present invention, the public spaces are public in the sense that they are not uniquely associated with any particular user or group of users and no user or group of users can exclude another user from the public space. Each private space, by contrast, is associated with a particular user from among a plurality of users. A private space is private in the sense that the particular user associated with the private space may restrict access to the private space by other users. The private spaces may take on the appearance of familiar private real estate

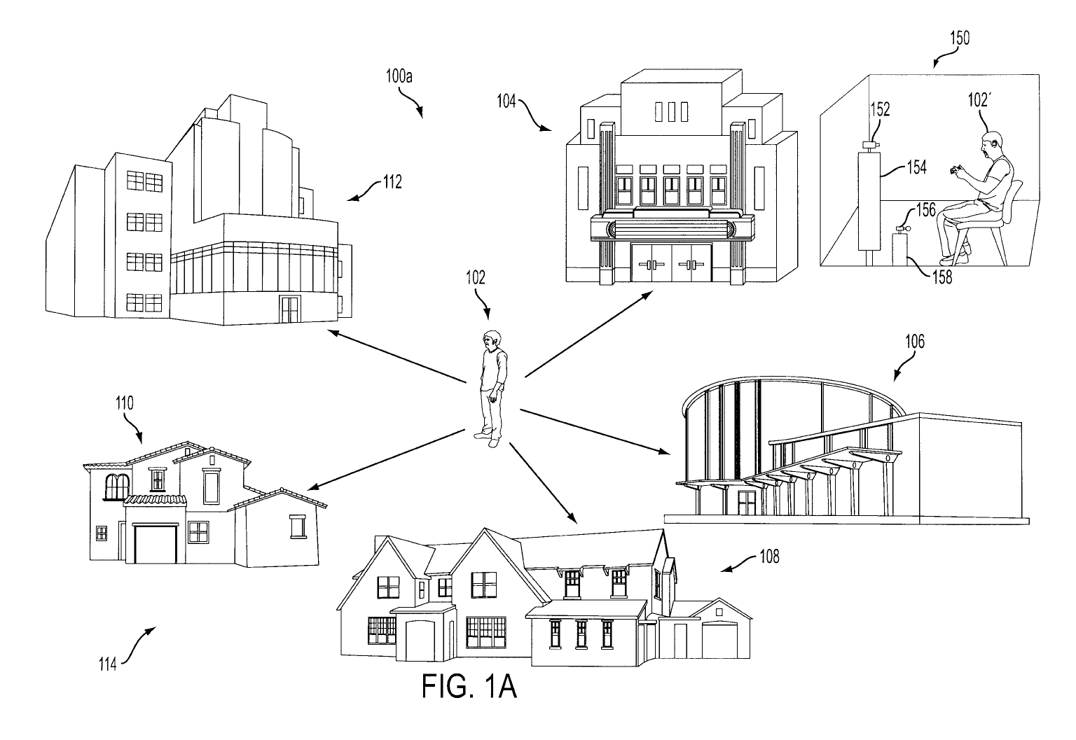

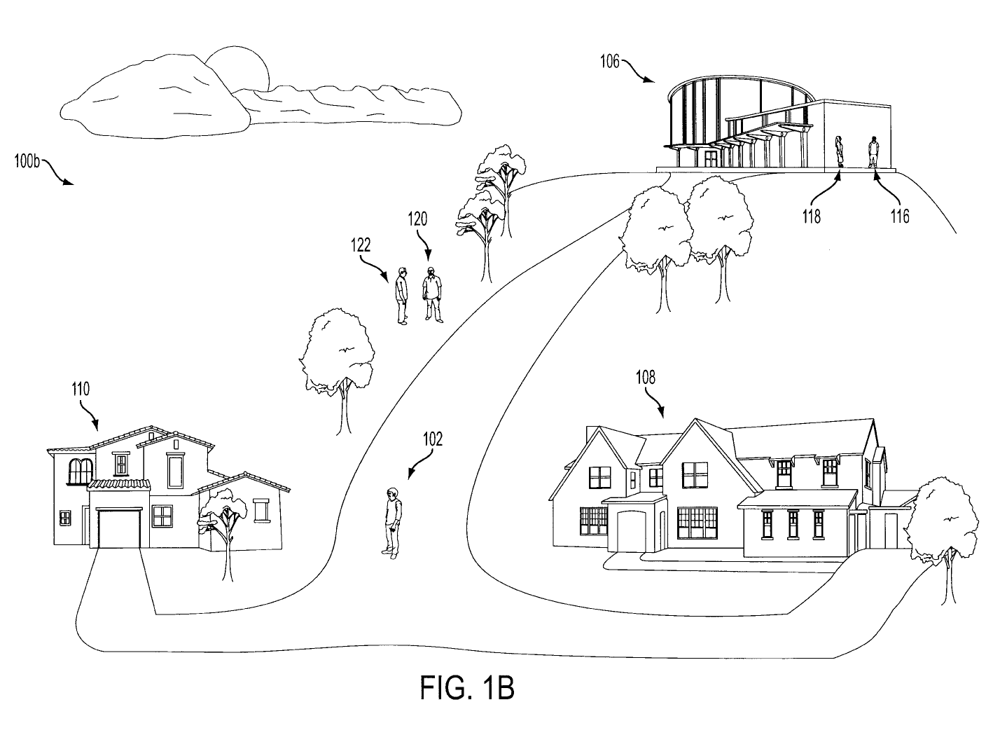

FIG. 1A illustrates a graphic diagram of a conceptual virtual space 100a, in accordance with one embodiment of the present invention. A user of an interactive game may be represented as an avatar on the display screen to illustrate the user's representation in the conceptual virtual space 100a. For example purposes, the user of a video game may be user A 102. User A 102 is free to roam around the conceptual virtual space 100a so as to visit different spaces within the virtual space. In the example illustrated, user A 102 may freely travel to a theater 104, a meeting space 106, user A home 110, user B home 108, or an outdoor space 114. Again, these spaces are similar to the spaces real people may visit in their real-world environment.

Moving the avatar representation of user A 102 about the conceptual virtual space 100a can be dictated by a real-world user 102′ moving a controller of a game console 158 and dictating movements of the avatar in different directions so as to virtually enter the various spaces of the conceptual virtual space 100a. The location 150 of the real-world user may be anywhere the user has access to a device that has access to the internet. In the example shown, the real-world user 102′ is viewing a display 154. A game system may also include a camera 152 for capturing reactions of the real-world user 102′ and a microphone 156 for observing sounds of the real-world user 102′. For more information on controlling avatar movement, reference may be made to U.S. patent application Ser. No. 11/789,202, entitled “Interactive user controlled avatar animations”, filed Apr. 23, 2007, is herein incorporated by reference. Reference may also be made to: (1) United Kingdom patent application no. 0703974.6 entitled “ENTERTAINMENT DEVICE”, filed on Mar. 1, 2007; (2) United Kingdom patent application no. 0704225.2 entitled “ENTERTAINMENT DEVICE AND METHOD”, filed on Mar. 5, 2007; (3) United Kingdom patent application no. 0704235.1 entitled “ENTERTAINMENT DEVICE AND METHOD”, filed on Mar. 5, 2007; (4) United Kingdom patent application no. 0704227.8 entitled “ENTERTAINMENT DEVICE AND METHOD”, filed on Mar. 5, 2007; and (5) United Kingdom patent application no. 0704246.8 entitled “ENTERTAINMENT DEVICE AND METHOD”, filed on Mar. 5, 2007, each of which is herein incorporated by reference.

FIG. 1B illustrates a virtual space 100b, defining additional detail of a virtual world in which user A may move around and interact with other users, objects, or communicate with other users or objects, in accordance with one embodiment of the present invention. As illustrated, user A 102 may have a user A home 110 in which user A 102 may enter, store things, label things, interact with things, meet other users, exchange opinions, or simply define as a home base for user A 102. User A 102 may travel in the virtual space 100b in any number of ways. One example may be to have user A 102 walk around the virtual space 100b so as to enter into or out of different spaces.

For example, user A 102 may walk over to user B home 108. Once at user B home 108, user A 102 can knock on the door, and seek entrance into the home of user B108. Depending on whether user A 102 has access to the home of user B, the home may remain closed to user A 102. Additionally, user B 116 (e.g., as controlled by a real-world users) may walk around the virtual space 100b and enter into or out of different spaces. User B 116 is currently shown in FIG. 1B as standing outside of meeting place 106. User B 116 is shown talking to user C 118 at meeting space 106. In virtual space 100b, user D 120 is shown talking to user E 122 in a common area. The virtual space 100b is shown to have various space conditions such as weather, roadways, trees, shrubs, and other aesthetic and interactive features to allow the various users to roam around, enter and exit different spaces for interactivity, define communication, leave notes for other users, or simply interact within virtual space 100b.

In one embodiment, user A 102 may interact with other users shown in the virtual space 100b. In other examples, the various users illustrated within the virtual space 100b may not actually be tied to a real-world user, and may simply be provided by the computer system and game program to illustrate activity and popularity of particular spaces within the virtual space 100b.

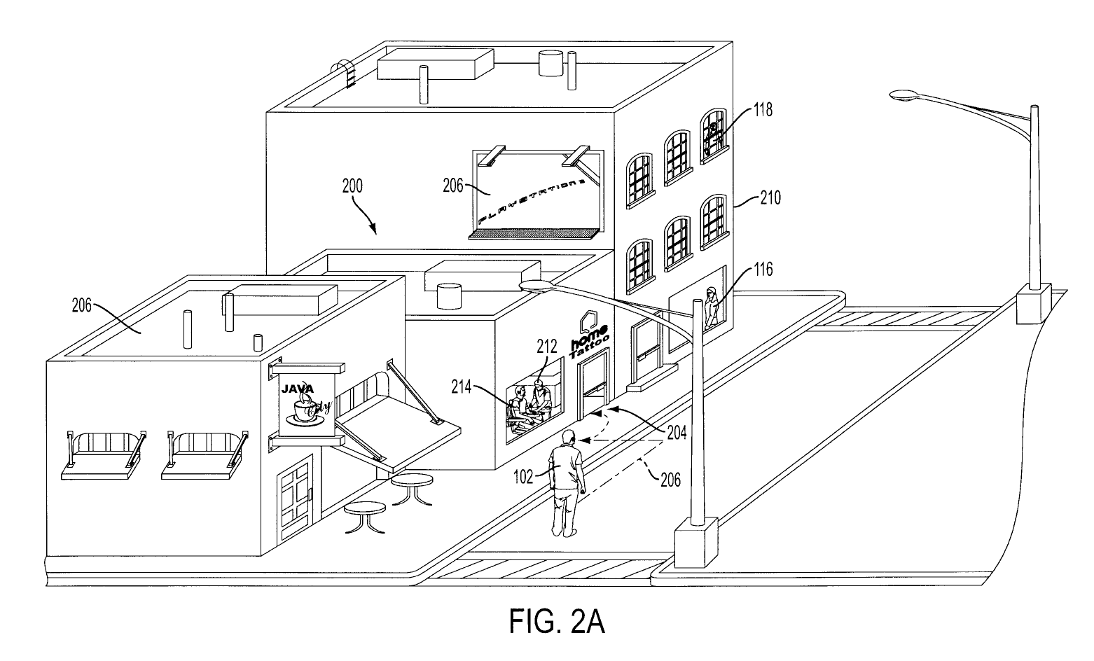

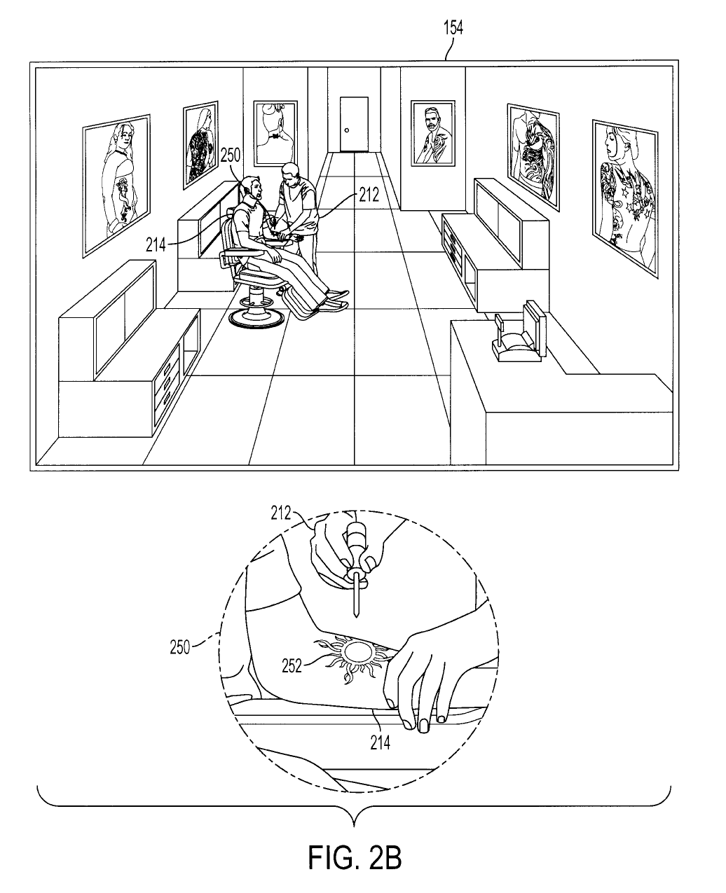

FIG. 2A is another exemplary illustration of a virtual space in accordance with one embodiment of the present invention. In this embodiment, the virtual space represents a more urban environment that virtual businesses such as coffee shop 206, a body modification business 200 along with an apartment building 210. The virtual business can include advertising signage along with billboard 206. User A 102 is shown within the virtual space as are user B 116 and user C 118 that as previously discussed, can be either user controlled avatars or computer controlled avatars.

The body modification business is a revenue generating entity within the virtual world where real-world users can have body modifications applied to their virtual world avatars. The body modification services allow a real-world user to personalize and customize their virtual world avatar so it is more representative of either the real-world user or a desired alter ego. In one embodiment, a real-world user has an account of virtual world dollars or credits to buy goods and services within the virtual world. In another embodiment, the real-world user can enter credit card information in order to purchase good or services within the virtual world.

FIG. 2A is illustrated from the perspective of a third person in order to show the user A 102 walking through the virtual space and taking path 206. The real-world user 102′ manipulates a controller so user A 102 moves along path 206. The view the real-world user 102′ sees is displayed on a screen from the perspective of user A 102 so where the user 102 looks into a store window of body modification business 200, it is viewed from the first person perspective of user A 102. From the view of user A 102, the real-world user 102′ sees an artist 212 applying a tattoo to avatar 214. As previously discussed, user A 102 can interact with the virtual world and path 206 indicates that user A 102 enters the body modification business through a door 204.

FIG. 2B is a representative illustration shown on screen 154 to the real-world user 102′ after user A 102 enters the body modification business, in accordance with one embodiment of the present invention. As previously viewed from the outside of the body modification business, avatar 214 is having a tattoo applied by artists 212. In some embodiments the avatar 214 is controlled by a real-world user while in other embodiments, the avatar 214 is computer controller. Similarly, the artists 212 can be either computer controller or controlled by a real-world user. For simplicity, the interior of the body modification business is only shown with avatar 214 and artists 212. However, in other embodiments, additional avatars and artists can be shown within the business. Additionally, other avatars can be shown browsing through tattoo catalogs and examining different piercings. In other embodiments, a lounge area within the business can allow real-world users to discuss additional body modification services through their avatars. The visual displayed on screen 154 is also accompanied by sounds to provide an immersive multimedia experience.

Detail 250 shows a close-up of artist 212 applying a tattoo 252 to the arm of avatar 214. The view illustrated in detail 250 is from the perspective a real-world user controller avatar 214. Real-world user 102′ could also have a similar view by manipulating user a 102 into a position to obtain a similar view. In one embodiment, the tattoo 252 is applied in near real-time in order to accurately simulate the application of a tattoo. However, as it is possible for complex tattoo to take prolonged periods to be applied, the real-world user can selectively apply time compression in order to reduce the amount of time spent in the body modification business. When applying time compression, the tattoo will not be instantly applied to the avatar, but rather the user will be able to watch the application of the tattoo as if it was captured via time-lapse photography.

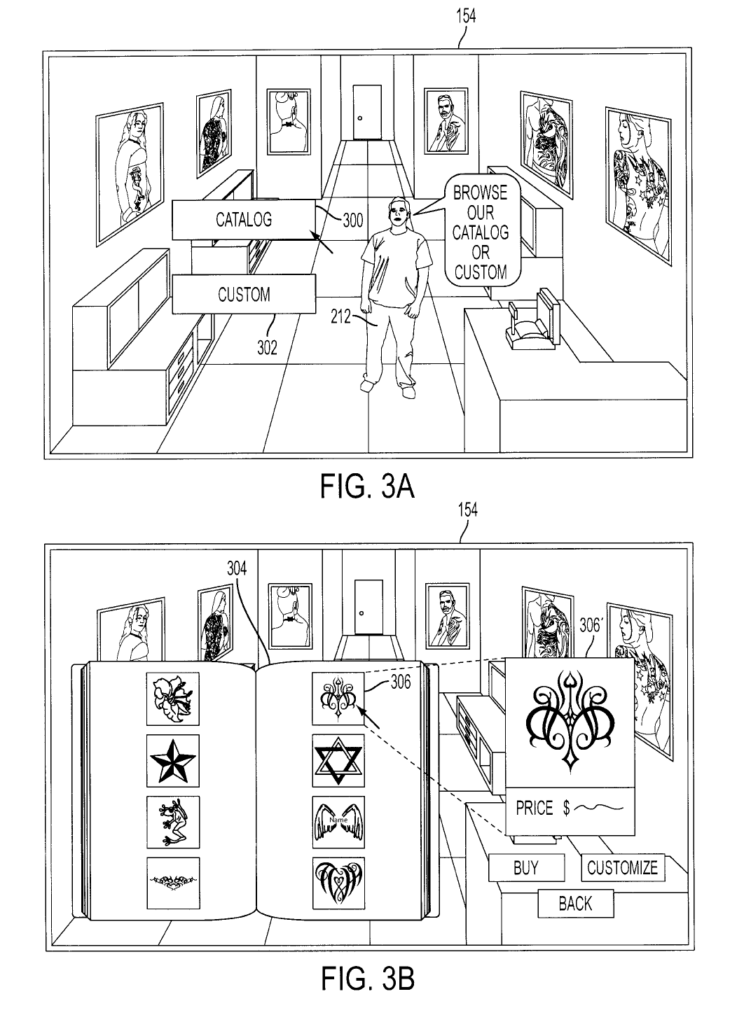

FIGS. 3A and 3B illustrate a body modification selection process that occurs within the body modification business, in accordance with one embodiment of the present invention. FIG. 3A is an exemplary simplified view on screen 154 from the perspective of user A 102 interacting with the artists 212. In on embodiment, this interaction is initiated via real-world user 102′ interaction with the controller. In another embodiment, the computer program an initiate the interaction by automatically prompting the real-world user 102′ with a question, such as, but not limited to, “Can I help you find a tattoo?”. In another embodiment, an automatic prompt can ask if user A would like some assistance followed by choices for tattoos, piercings, brandings, or other body modifications.

FIG. 3A allows the real-world user to select between catalogues 300 of tattoos or piercings or provide custom artwork 302. Selecting to view catalogues 300, results in the screen 154 as shown in FIG. 3B. A catalog 304 is displayed with various body art images such as image 306. The pages of the catalog 304 can be browsed like a book or searched based on keywords. In one embodiment, the catalog 304 can be indexed and cross-referenced based on types of tattoos such as, but not limited to, animals, flowers, patterns, and symbols.

In one embodiment, when the real-world user selects image 306, a detailed view 306a is shown on the screen 154. The detailed view 306a provides the real-world user with a larger image of the tattoo and can include additional information such as a virtual world price. When examining a tattoo in the detailed view 306a, the user can choose to customize the tattoo. Customization can include the size of the tattoo along with varying the colors of the selected tattoo. In some embodiments, customization includes allowing the real-world user to edit or modify the tattoo with a graphics editing program.

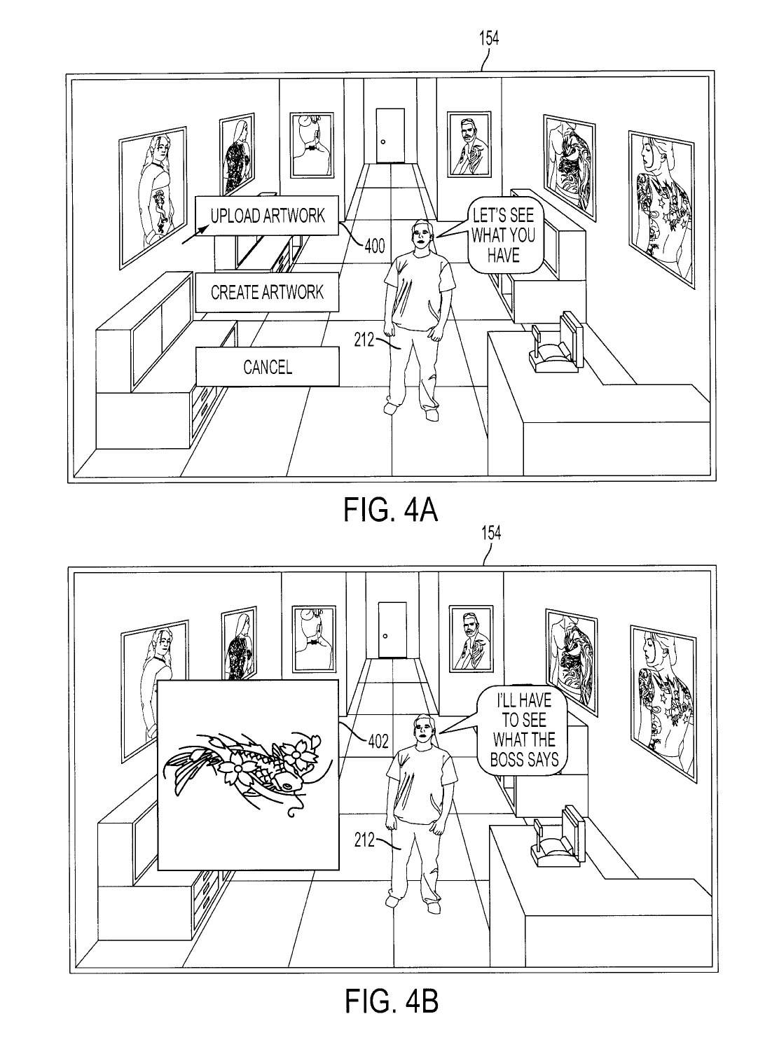

FIGS. 4A and 4B illustrate an exemplary sequence that is displayed on screen 154 when a user selects to upload custom user-generated artwork, in accordance with one embodiment of the present invention. After selecting to upload custom artwork from a screen similar FIG. 3A, the artist 212 can be animated to say “Let's see what you have.” Additionally, the real-world user can select upload artwork 400 from various choices on the display. After selecting upload artwork 400, the real-world user can browse for saved graphics files stored on internal, external or networked storage devices associated with a processor module. The real-world user selects a saved graphics file and the graphic file 402 is uploaded to a server and displayed on the screen 154, as shown in FIG. 4B. As will be discussed below, uploaded artwork is subjected to various levels of scrutiny in order to provide a virtual world environment suitable for a wide variety of real-world age groups.

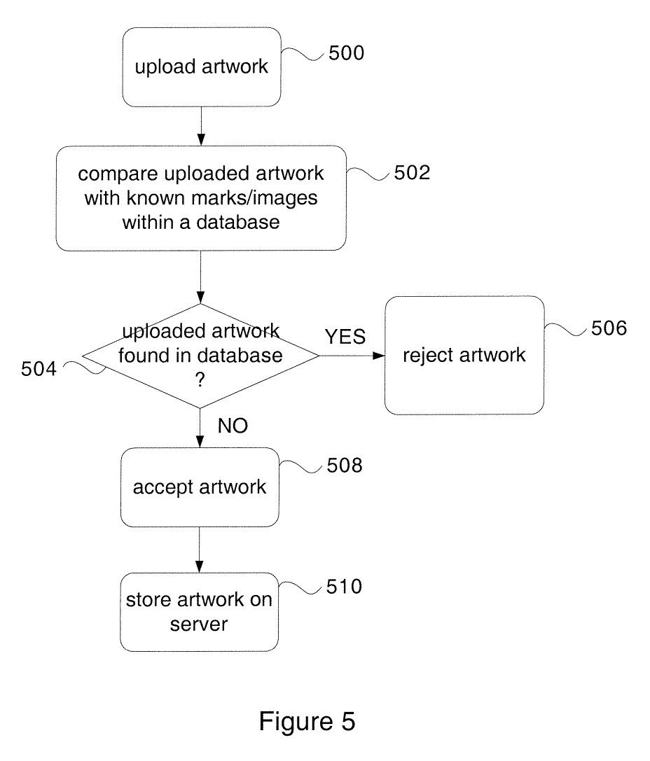

FIG. 5 is a flow chart illustrating operations to examine uploaded artwork, in accordance with one embodiment of the present invention. In order to moderate and control the type of user-generated content within the virtual world, uploaded graphics files that are to be used as a tattoo or body modification are subjected to review. The review process is used to determine if the user-generated content contains profanity, vulgarity, or trademarked and/or copyrighted material. In one embodiment, the review process includes automated review where operation 500 is where a real-world user uploads a graphics files that is to be used as a tattoo to a server. Operation 502 compares the uploaded graphics file with known trademarks and copyrighted images stored within a database. Operation 502 can also be used to compare the user-generated content with known images and shapes that have been deemed profane or vulgar. Various techniques can be used to compare the uploaded images such as pixel-by-pixel comparisons along or pattern recognition. Operation 504 is determines if the uploaded image is found within the database of known trademarks, copyrights, profanity and vulgarity. In one embodiment, if the uploaded image is found within the database, operation 504 rejects the uploaded image. In another embodiment, user-generated content that is deemed profane or vulgar maybe treated differently. For example, profane or vulgar user-generated content can be assigned a rating similar to the rating system used by the Motion Picture Association of America (MPAA) or the Entertainment Software Rating Board (ESRB). The use of a rating system in conjunction with user defined permissions or filters could allow viewing of mature body modification to be restricted to real-world users with the appropriate permissions or filters. If the uploaded images is not found within the database, operation 508 accepts the images and operation 510 stores the uploaded image on the tattoo image server.

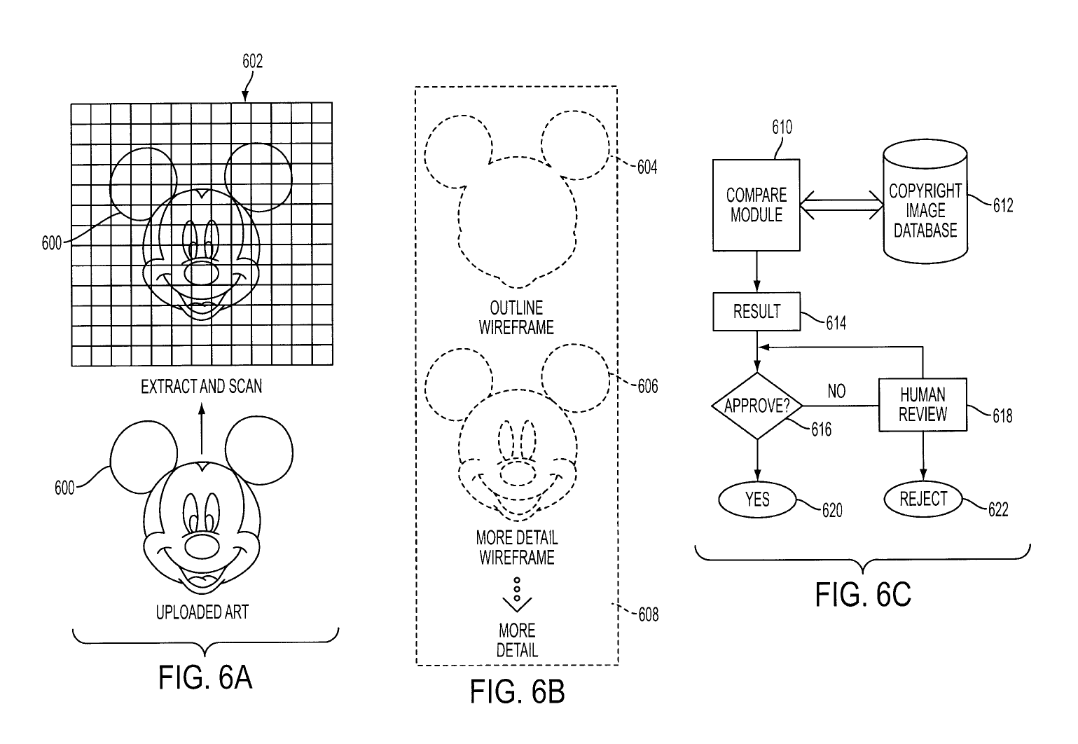

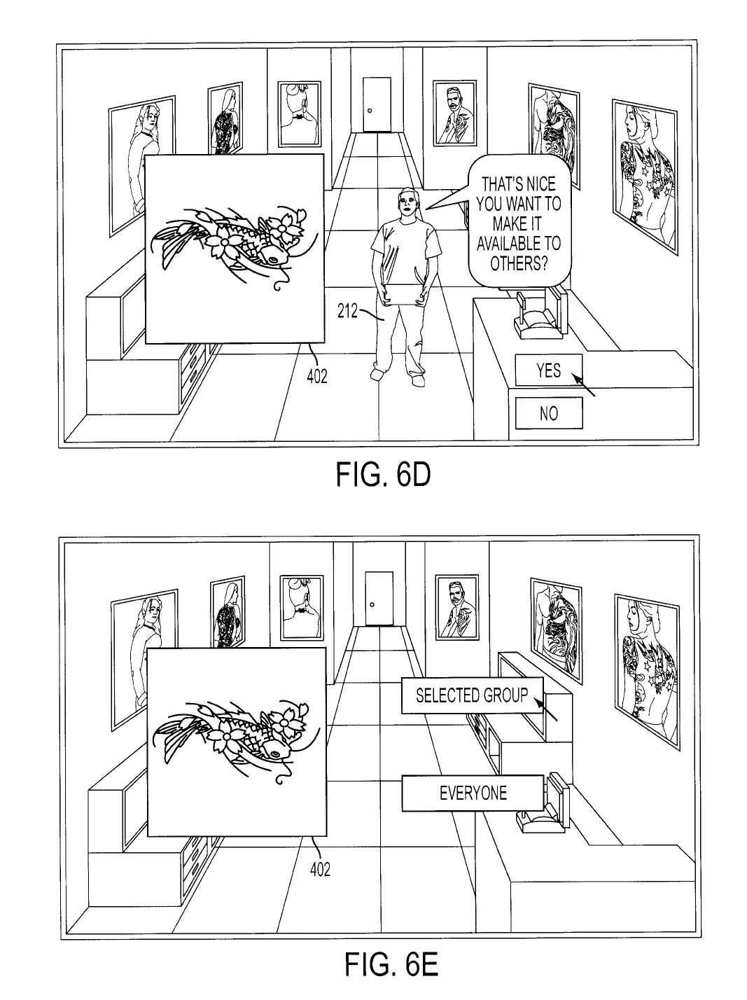

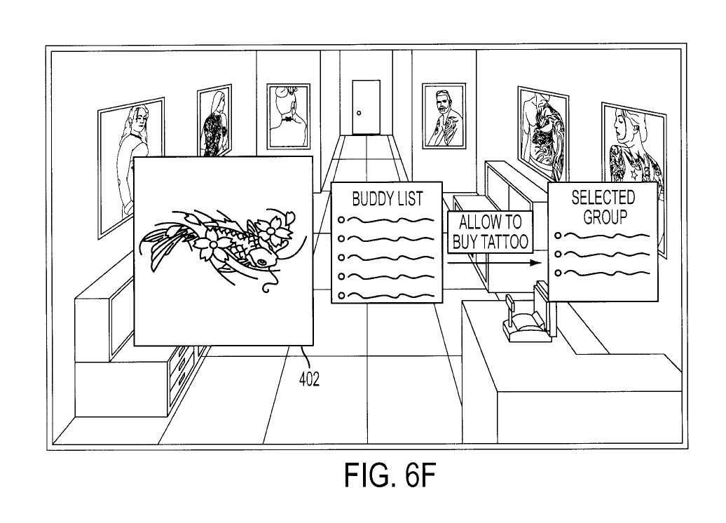

FIGS. 6A-6C are exemplary schematics illustrating a technique to extract and scan an uploaded image 600 for comparison to known trademarks and images, in accordance with one embodiment of the present invention. In FIG. 6A the uploaded image 600 is extracted and scanned using a grid 602. The grid 602 allows an outline wireframe 604 the image to made as shown in FIG. 6B. The outline wireframe 604 is loaded into the comparison module 610 of FIG. 6C. The comparison module 610 also has access an image database 612 and compares the wireframe 604 to the images within the image database 612. The comparison module 610 renders a result 614 based on the comparison between the uploaded image and the images within the image database 612. If the uploaded image is not found within the image database, the uploaded image is approved. If the uploaded image is found within the image database, the uploaded image is sent for human review 618. In one embodiment, before the image is approved by the automated review more detailed wireframe models are created and entered into the comparison module 610. As shown in FIG. 6B, wireframe models with increasing detail can be created from the uploaded image.

FIGS. 6D-6F are exemplary screens illustrating how a user can share approved artwork, in accordance with one embodiment of the present invention. FIG. 6D is an exemplary scene displayed on screen 154 after uploaded artwork has been approved. The uploaded image 402 is displayed along with artists 212. Once an uploaded image is approved, the artists 212 prompts the real-world user to decide if they would like to share the approved artwork with others. Selecting yes 650 in FIG. 6D allows a user to share the approved artwork that is currently stored on the server. As shown in FIG. 6E, a real-world user can choose to share approved images with a select group of people or all users within the virtual world.

In one embodiment, choosing to share the approved artwork with everyone in the virtual world adds the approved image to the tattoo catalogue. Conversely, if a real-world user chooses to share the approved image with only a select group, the real-world user selects or enters the select group that will have access to the approved image, as shown in FIG. 6F. In one embodiment, when a user shares their user provided artwork within the tattoo catalogue, the originating user can receive virtual world credit when another user purchases the artwork. For example, the originating user can set the virtual world price for the artwork and receive a percentage of the price as credit when other users purchase the artwork. In another example, user provided artwork within the catalogue is all sold at a predetermined price and when another user purchases the artwork, the originating user receives a pre-determined credit.

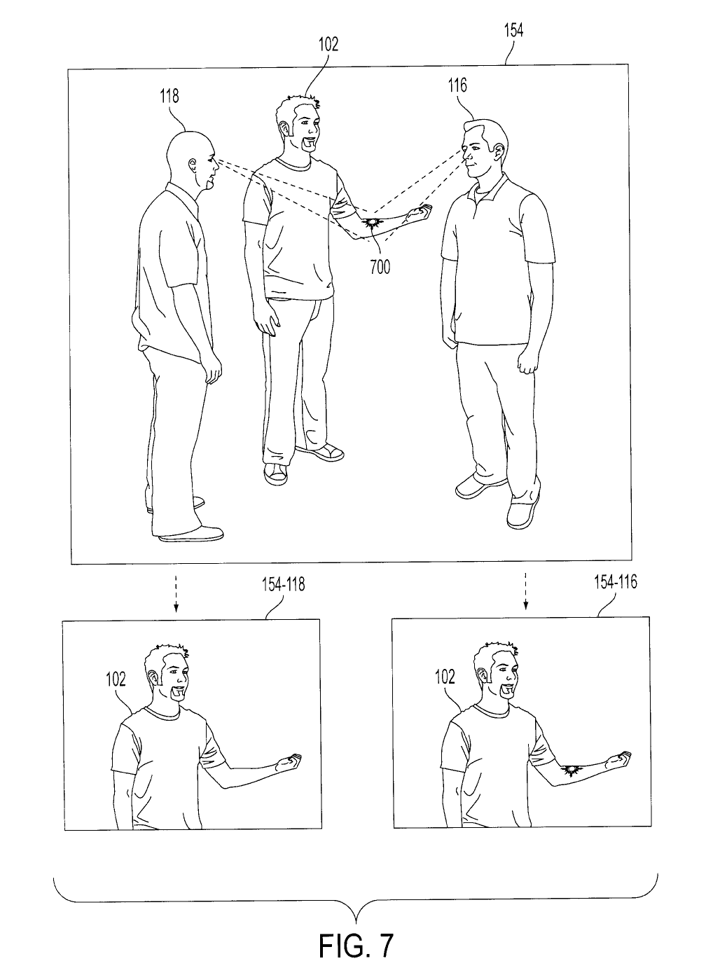

FIG. 7 illustrates how permissions allow particular viewers to see virtual body art while other viewers are blocked from seeing the virtual body art, in accordance with one embodiment of the present invention. In order to maintain an environment acceptable to all age groups, a user setting can be applied that prevents particular body modifications from being viewed by a user. In one embodiment, the user setting is a parental control that blocks a child from seeing all body modifications on all avatars within the virtual world. In another embodiment, the user setting allows an individual user to view body modification based on a rating system ranging from everyone to adults only. In the rating system embodiment all body modification would be assigned a corresponding rating. In another embodiment, users are allowed to set privileges regarding which viewers are allowed to see various body modifications. User set privileges can be used in conjunction with other parental controls or a rating system.

FIG. 7 is an exemplary view of screen 154 from a third person who can see user A 102 with virtual body art 700, user B 116 and user C 118. FIG. 7 also includes screen 154-118 that shows user A 102 from the perspective of user C 118. Similarly, screen 154-116 shows user A 102 from the perspective of user B 116. In this embodiment, user B 116 can see the body modification 700 on user A 102. Conversely, user C 188, who does not have permission to see body modifications, cannot see the body modification 700 on user A 102.

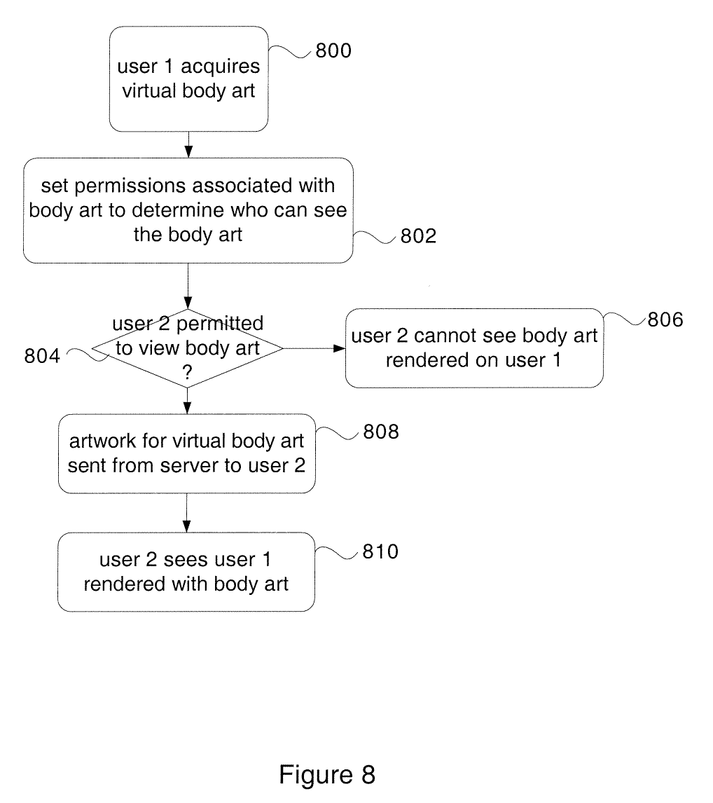

FIG. 8 is an exemplary flow chart illustrating how virtual body modifications are filtered, in accordance with one embodiment of the present invention. With operation 800, a body modification is acquired for a virtual world avatar representing a first user. Operation 802 allows the real-world user to set permission on who can view the body modification. Operation 802 can also include the setting of the real-world user's rating system that determines the type of body modifications that are viewable. As the avatar for the first user moves around the virtual world and is visible to other users, operation 804 checks to see if the other users are able to see the body modification of the first user. In one embodiment, the ability to see the body modification is determined by a combination of a rating system and the first user's permissions. In another embodiment, only a rating system is used to determine whether other users can see the first user's body modification.

If another user is not allowed to see the body modification, operation 806 results in the first user being displayed without the body modification. On the other hand, if another user is allowed to see the body modification, operation 808 sends the artwork for the body modification from a server to the user's client. In another embodiment of operation 808, the body modification artwork can be transferred from a memory associated with the first user to the other users via a peer-to-peer network. In still other embodiments, hybrids of server-client and peer-to-peer networks can be used to provide necessary body modification artwork to the appropriate users. Operation 810 renders the artwork on the first user and the second user sees the first user with the body modification. When a second user views the body modification of the first user, an automatic prompt can allow the second user to remember the body modification within an avatar memory. In another embodiment when the second user see the body modification of the first user a notice function is automatically triggered and a thumbnail or preview image of the body modification is stored into an avatar memory.

In one embodiment, the avatar memory is a database associated with each avatar that is used to store triggered functions, experiences, and events as a real-world user navigates the virtual world. Other trigger functions, experiences, and event include, but are not limited to viewing virtual world advertising, text chats with other avatars, and places visited within the virtual world. Additionally, a real-world user can manipulate a controller to automatically store an event within their avatar memory. In one embodiment, data within an avatar memory can be shared with virtual world advertisers in order to determine a distinct number of views an advertisement is receiving. Similarly, a user can access their avatar memory to review body modification they saw while navigating the virtual world. In another embodiment, when selecting a body modification from a catalogue, a real-world user can access their avatar memory to identify and select body art they would like to have on their virtual world avatar. In this manner, an avatar with desirable body modification can stimulate the virtual world economy by creating demand among real-world users to apply body modifications to their virtual world avatars. Similarly, access to body modifications can be controlled within a select group to create a cache within the virtual world. In other embodiments, advertising campaigns can distribute access to temporary body modification in order to create advertising buzz among targeted groups.

The trigger functions, events and experiences are executed by one or more computer systems executing program instructions to generate a virtual world simulating a real-world environment. The trigger functions are merely exemplary of program instructions that are processed, stored on a memory device, and exchanged over computer networks to generate and control avatar interactions within the virtual world. The processed instructions can result in saving data associated with an avatar memory and allow real-world users to recall past events viewed by their avatar.

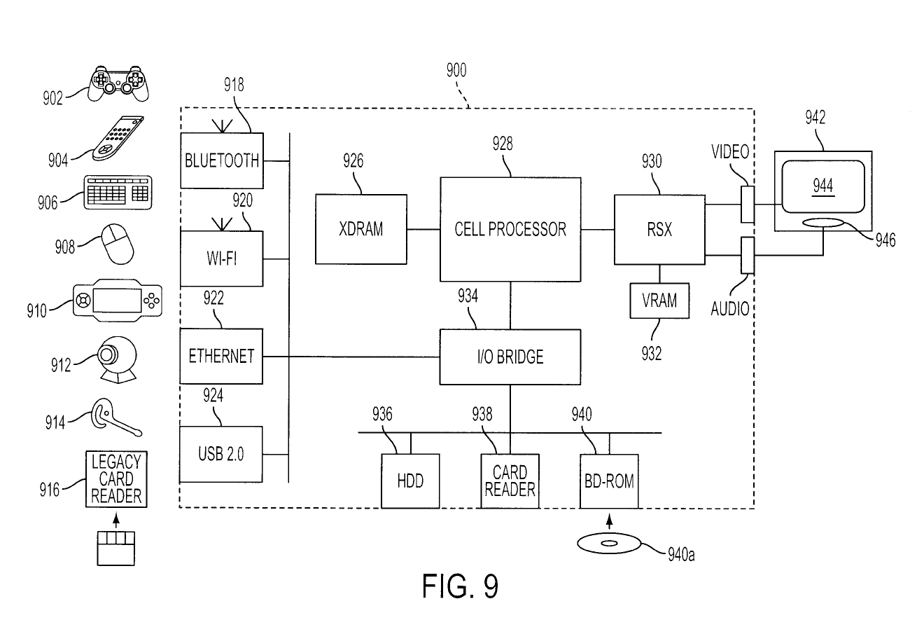

FIG. 9 schematically illustrates the overall system architecture of the Sony® Playstation 3® entertainment device, a console having controllers for implementing an avatar control system in accordance with one embodiment of the present invention. A system unit 900 is provided, with various peripheral devices connectable to the system unit 900.The system unit 900 comprises: a Cell processor 928; a Rambus® dynamic random access memory (XDRAM) unit 926; a Reality Synthesizer graphics unit 930 with a dedicated video random access memory (VRAM) unit 932; and an I/O bridge 934. The system unit 900 also comprises a Blu Ray® Disk BD-ROM® optical disk reader 940 for reading from a disk 940a and a removable slot-in hard disk drive (HDD) 936, accessible through the I/O bridge 934. Optionally the system unit 900 also comprises a memory card reader 938 for reading compact flash memory cards, Memory Stick® memory cards and the like, which is similarly accessible through the I/O bridge 934.

The I/O bridge 934 also connects to six Universal Serial Bus (USB) 2.0 ports 924; a gigabit Ethernet port 922; an IEEE 802.11b/g wireless network (Wi-Fi) port 920; and a Bluetooth® wireless link port 918 capable of supporting of up to seven Bluetooth connections.

In operation the I/O bridge 934 handles all wireless, USB and Ethernet data, including data from one or more game controllers 902. For example when a user is playing a game, the I/O bridge 934 receives data from the game controller 902 via a Bluetooth link and directs it to the Cell processor 928, which updates the current state of the game accordingly.

The wireless, USB and Ethernet ports also provide connectivity for other peripheral devices in addition to game controllers 902, such as: a remote control 904; a keyboard 906; a mouse 908; a portable entertainment device 910 such as a Sony Playstation Portable® entertainment device; a video camera such as an EyeToy® video camera 912; and a microphone headset 914. Such peripheral devices may therefore in principle be connected to the system unit 900 wirelessly; for example the portable entertainment device 910 may communicate via a Wi-Fi ad-hoc connection, whilst the microphone headset 914 may communicate via a Bluetooth link.

The provision of these interfaces means that the Playstation 3 device is also potentially compatible with other peripheral devices such as digital video recorders (DVRs), set-top boxes, digital cameras, portable media players, Voice over IP telephones, mobile telephones, printers and scanners.

In addition, a legacy memory card reader 916 may be connected to the system unit via a USB port 924, enabling the reading of memory cards 948 of the kind used by the Playstation® or Playstation 2® devices.

In the present embodiment, the game controller 902 is operable to communicate wirelessly with the system unit 900 via the Bluetooth link. However, the game controller 902 can instead be connected to a USB port, thereby also providing power by which to charge the battery of the game controller 902. In addition to one or more analog joysticks and conventional control buttons, the game controller is sensitive to motion in six degrees of freedom, corresponding to translation and rotation in each axis. Consequently gestures and movements by the user of the game controller may be translated as inputs to a game in addition to or instead of conventional button or joystick commands. Optionally, other wirelessly enabled peripheral devices such as the Playstation Portable device may be used as a controller. In the case of the Playstation Portable device, additional game or control information (for example, control instructions or number of lives) may be provided on the screen of the device. Other alternative or supplementary control devices may also be used, such as a dance mat (not shown), a light gun (not shown), a steering wheel and pedals (not shown) or bespoke controllers, such as a single or several large buttons for a rapid-response quiz game (also not shown).

The remote control 904 is also operable to communicate wirelessly with the system unit 900 via a Bluetooth link. The remote control 904 comprises controls suitable for the operation of the Blu Ray Disk BD-ROM reader 940 and for the navigation of disk content.

The Blu Ray Disk BD-ROM reader 940 is operable to read CD-ROMs compatible with the Playstation and PlayStation 2 devices, in addition to conventional pre-recorded and recordable CDs, and so-called Super Audio CDs. The reader 940 is also operable to read DVD-ROMs compatible with the Playstation 2 and PlayStation 3 devices, in addition to conventional pre-recorded and recordable DVDs. The reader 940 is further operable to read BD-ROMs compatible with the Playstation 3 device, as well as conventional pre-recorded and recordable Blu-Ray Disks.

The system unit 900 is operable to supply audio and video, either generated or decoded by the Playstation 3 device via the Reality Synthesizer graphics unit 930, through audio and video connectors to a display and sound output device 942 such as a monitor or television set having a display 944 and one or more loudspeakers 946. The audio connectors 950 may include conventional analogue and digital outputs whilst the video connectors 952 may variously include component video, S-video, composite video and one or more High Definition Multimedia Interface (HDMI) outputs. Consequently, video output may be in formats such as PAL or NTSC, or in 720p, 1080i or 1080p high definition.

Audio processing (generation, decoding and so on) is performed by the Cell processor 928. The Playstation 3 device's operating system supports Dolby® 5.1 surround sound, Dolby® Theatre Surround (DTS), and the decoding of 7.1 surround sound from Blu-Ray® disks.

In the present embodiment, the video camera 912 comprises a single charge coupled device (CCD), an LED indicator, and hardware-based real-time data compression and encoding apparatus so that compressed video data may be transmitted in an appropriate format such as an intra-image based MPEG (motion picture expert group) standard for decoding by the system unit 900. The camera LED indicator is arranged to illuminate in response to appropriate control data from the system unit 900, for example to signify adverse lighting conditions. Embodiments of the video camera 912 may variously connect to the system unit 900 via a USB, Bluetooth or Wi-Fi communication port. Embodiments of the video camera may include one or more associated microphones and also be capable of transmitting audio data. In embodiments of the video camera, the CCD may have a resolution suitable for high-definition video capture. In use, images captured by the video camera may for example be incorporated within a game or interpreted as game control inputs.

In general, in order for successful data communication to occur with a peripheral device such as a video camera or remote control via one of the communication ports of the system unit 900, an appropriate piece of software such as a device driver should be provided. Device driver technology is well-known and will not be described in detail here, except to say that the skilled man will be aware that a device driver or similar software interface may be required in the present embodiment described.

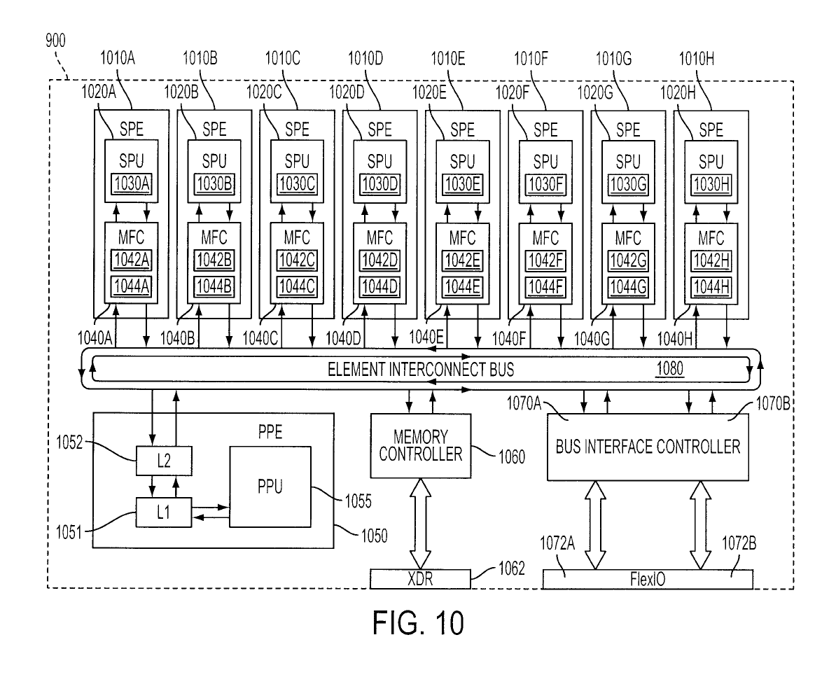

FIG. 10 is a schematic of the Cell processor 928 in accordance with one embodiment of the present invention. The Cell processors 928 has an architecture comprising four basic components: external input and output structures comprising a memory controller 1060 and a dual bus interface controller 1070A,B; a main processor referred to as the Power Processing Element 1050; eight co-processors referred to as Synergistic Processing Elements (SPEs) 1010A-H; and a circular data bus connecting the above components referred to as the Element Interconnect Bus 1080. The total floating point performance of the Cell processor is 218 GFLOPS, compared with the 6.2 GFLOPs of the Playstation 2 device's Emotion Engine.

The Power Processing Element (PPE) 1050 is based upon a two-way simultaneous multithreading Power 970 compliant PowerPC core (PPU) 1055 running with an internal clock of 3.2 GHz. It comprises a 512 kB level 2 (L2) cache and a 32 kB level 1 (L1) cache. The PPE 1050 is capable of eight single position operations per clock cycle, translating to 25.6 GFLOPs at 3.2 GHz. The primary role of the PPE 1050 is to act as a controller for the Synergistic Processing Elements 1010A-H, which handle most of the computational workload. In operation the PPE 1050 maintains a job queue, scheduling jobs for the Synergistic Processing Elements 1010A-H and monitoring their progress. Consequently each Synergistic Processing Element 1010A-H runs a kernel whose role is to fetch a job, execute it and synchronizes with the PPE 1050.

Each Synergistic Processing Element (SPE) 1010A-H comprises a respective Synergistic Processing Unit (SPU) 1020A-H, and a respective Memory Flow Controller (MFC) 1040A-H comprising in turn a respective Dynamic Memory Access Controller (DMAC) 1042A-H, a respective Memory Management Unit (MMU) 1044A-H and a bus interface (not shown). Each SPU 1020A-H is a RISC processor clocked at 3.2 GHz and comprising 256 kB local RAM 1030A-H, expandable in principle to 4 GB. Each SPE gives a theoretical 25.6 GFLOPS of single precision performance. An SPU can operate on 4 single precision floating point members, 4 32-bit numbers, 8 16-bit integers, or 16 8-bit integers in a single clock cycle. In the same clock cycle it can also perform a memory operation. The SPU 1020A-H does not directly access the system memory XDRAM 926; the 64-bit addresses formed by the SPU 1020A-H are passed to the MFC 1040A-H which instructs its DMA controller 1042A-H to access memory via the Element Interconnect Bus 1080 and the memory controller 1060.

The Element Interconnect Bus (EIB) 1080 is a logically circular communication bus internal to the Cell processor 928 which connects the above processor elements, namely the PPE 1050, the memory controller 1060, the dual bus interface 1070A,B and the 8 SPEs 1010A-H, totaling 12 participants. Participants can simultaneously read and write to the bus at a rate of 8 bytes per clock cycle. As noted previously, each SPE 1010A-H comprises a DMAC 1042A-H for scheduling longer read or write sequences. The EIB comprises four channels, two each in clockwise and anti-clockwise directions. Consequently for twelve participants, the longest step-wise data-flow between any two participants is six steps in the appropriate direction. The theoretical peak instantaneous EIB bandwidth for 12 slots is therefore 96B per clock, in the event of full utilization through arbitration between participants. This equates to a theoretical peak bandwidth of 307.2 GB/s (gigabytes per second) at a clock rate of 3.2 GHz.

The memory controller 1060 comprises an XDRAM interface 1062, developed by Rambus Incorporated. The memory controller interfaces with the Rambus XDRAM 926 with a theoretical peak bandwidth of 25.6 GB/s.

The dual bus interface 1070A,B comprises a Rambus FlexIO® system interface 1072A,B. The interface is organized into 12 channels each being 8 bits wide, with five paths being inbound and seven outbound. This provides a theoretical peak bandwidth of 62.4 GB/s (36.4 GB/s outbound, 26 GB/s inbound) between the Cell processor and the I/O Bridge 700 via controller 170A and the Reality Simulator graphics unit 200 via controller 170B.

Data sent by the Cell processor 928 to the Reality Simulator graphics unit 930 will typically comprise display lists, being a sequence of commands to draw vertices, apply textures to polygons, specify lighting conditions, and so on. Embodiments may include capturing depth data to better identify the real-world user and to direct activity of an avatar or scene. The object can be something the person is holding or can also be the person's hand. In the this description, the terms “depth camera” and “three-dimensional camera” refer to any camera that is capable of obtaining distance or depth information as well as two-dimensional pixel information. For example, a depth camera can utilize controlled infrared lighting to obtain distance information. Another exemplary depth camera can be a stereo camera pair, which triangulates distance information using two standard cameras. Similarly, the term “depth sensing device” refers to any type of device that is capable of obtaining distance information as well as two-dimensional pixel information.

Recent advances in three-dimensional imagery have opened the door for increased possibilities in real-time interactive computer animation. In particular, new “depth cameras” provide the ability to capture and map the third-dimension in addition to normal two-dimensional video imagery. With the new depth data, embodiments of the present invention allow the placement of computer-generated objects in various positions within a video scene in real-time, including behind other objects.

Moreover, embodiments of the present invention provide real-time interactive gaming experiences for users. For example, users can interact with various computer-generated objects in real-time. Furthermore, video scenes can be altered in real-time to enhance the user's game experience. For example, computer generated costumes can be inserted over the user's clothing, and computer generated light sources can be utilized to project virtual shadows within a video scene. Hence, using the embodiments of the present invention and a depth camera, users can experience an interactive game environment within their own living room. Similar to normal cameras, a depth camera captures two-dimensional data for a plurality of pixels that comprise the video image. These values are color values for the pixels, generally red, green, and blue (RGB) values for each pixel. In this manner, objects captured by the camera appear as two-dimension objects on a monitor.

Embodiments of the present invention also contemplate distributed image processing configurations. For example, the invention is not limited to the captured image and display image processing taking place in one or even two locations, such as in the CPU or in the CPU and one other element. For example, the input image processing can just as readily take place in an associated CPU, processor or device that can perform processing; essentially all of image processing can be distributed throughout the interconnected system. Thus, the present invention is not limited to any specific image processing hardware circuitry and/or software. The embodiments described herein are also not limited to any specific combination of general hardware circuitry and/or software, nor to any particular source for the instructions executed by processing components.

With the above embodiments in mind, it should be understood that the invention may employ various computer-implemented operations involving data stored in computer systems. These operations include operations requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The above described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

The invention can also be embodied as computer readable code on a computer readable medium. The computer readable medium is any data storage device that can store data which can be thereafter read by a computer system, including an electromagnetic wave carrier. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for applying body modifications to an avatar in a virtual world environment, comprising:
(a) detecting movement of the avatar into a facility, the facility being a virtual world representation of a body modification facility;
(b) requesting submission of a body modification to be applied to the avatar;
(c) receiving the submission of the body modification, the submission being a graphic illustration of the body modification;
(d) sending the submission of the body modification to a review process, the review process being conducted to monitor body modifications within the virtual world environment;
(e) applying the body modification to the avatar once the body modification has passed the review process.

2. The method as recited in claim 1, wherein applying the body modification to the avatar is performed in a time period substantially corresponding to a real-time period to apply a similar real-world body modification, during the time period avatar animations illustrate the application of the body modification.

3. The method as recited in claim 2, wherein the time period to apply the body modification to the avatar is compressed.

4. The method as recited in claim 1, wherein the review process is an automated review process, further comprising:
(i) extracting pixel data of the submitted body modification;
(ii) comparing the extracted pixel data to pixel data of known trademarked and copyrighted images; and
(iii) rejecting the body modification when a threshold value of similarity to a copyrighted image is exceeded, if the threshold value of similarity to a copyright image is not exceeded, the body modification is approved.

5. The method as recited in claim 4, wherein body modifications that have been rejected by the automated review process are subjected to human review.

6. The method as recited in claim 1, wherein the body modification that passes the review process is added to a library of approved body modifications.

7. A computer implemented method for executing a network application, the network application defined to render a virtual environment, the virtual environment being depicted by computer graphics, comprising:
(a) generating an animated user within the virtual environment;
(b) generating a facility, the facility generated within the virtual environment and being rendered as an interactive virtual representation of a body alteration business;
(c) detecting movement of the animated user into a facility;
(d) providing interaction between a facility employee and the animated user, the facility employee being an application controlled avatar, and the interactions rendered from a perspective of the animated user, the interactions including;
(i) requesting submission of a proposed body alteration;
(ii) receiving the proposed body alteration;
(iii) sending the proposed body alteration to a review process;
(iv) animating the application of an approved body alteration, the animation rendered from a perspective of the animated user observing the application of the body alteration in substantially real-time.

8. The method as recited in claim 7, wherein the review process is an automated review process, further comprising:
(i) saving the proposed body alteration on a server;
(ii) extracting pixel data of the proposed body modification;
(iii) comparing the extracted pixel data to pixel data of known trademarked and copyrighted images; and
(iv) rejecting the body modification when a threshold value of similarity to a copyrighted image is exceeded, if the threshold value of similarity to a copyright image is not exceeded, the body modification is approved.

9. The method as recited in claim 8, wherein rejected body modifications are subjected to human review.

10. The method as recited in claim 7, wherein the substantially real-time application of the approved body alteration is accelerated so as to appear as a time-lapse animation.

11. The method as recited in claim 7, wherein user defined permissions determine whether other users within the virtual environment are able to view body alterations.

12. Computer readable media including program instructions for applying body modifications to an avatar in a virtual world environment, comprising:
(a) program instructions for detecting movement of the avatar into a facility, the facility being a virtual world representation of a body modification facility;
(b) program instruction for requesting submission of a body modification to be applied to the avatar;
(c) program instruction for receiving the submission of the body modification, the submission being a graphic illustration of the body modification;
(d) program instruction for sending the submission of the body modification to a review process, the review process being conducted to monitor body modifications within the virtual world environment;
(e) program instruction for applying the body modification to the avatar once the body modification has passed the review process.

13. The computer readable media of claim 12, further comprising:
program instructions for animating the application of the body modification to the avatar, the animation displayed from a viewpoint of the avatar in substantially real time.

14. The computer readable media of claim 13, further comprising:
program instructions for accelerating the animation of the application of the body modification, the program instructions animating the application in a time-lapse sequence.
